(19) United States
(12) Patent Application Publication
(10) Pub. No.: US 2016/0221377 A1
(43) Pub. Date: Aug. 4, 2016

(54) THERMAL TRANSFER PAPER FOR PRINTING AND DIGITAL PRINTING

(71) Applicant: Dai Hyun Kim, Seoul (KR)

(72) Inventor: Dai Hyun Kim, Seoul (KR)

(21) Appl. No.: 15/095,322

(22) Filed: Apr. 11, 2016

Related U.S. Application Data
(63) Continuation of application No. PCT/KR2013/009786, filed on Oct. 31, 2013.

(30) Foreign Application Priority Data
Oct. 11, 2013 (KR) 10-2013-0121292

(51) Int. Cl. B41M 5/42; B41M 5/382; B41M 5/392

(52) U.S. Cl. CPC B41M 5/42; B41M 5/392; B41M 5/38214; B41M 2205/02; B41M 2205/38; B41M 2205/30

(57) ABSTRACT

A thermal transfer paper for printing or digital printing includes a release paper and a thermal transfer layer, wherein the thermal transfer layer is a semitransparent or opaque coating layer in which ink used by a printer or a digital printer is absorbed therein such that a color patterned layer is formed. Accordingly, the thermal transfer paper can be used regardless of the printing method and the kind of ink according to the printing method and allows thermal transferring to be carried out at a temperature of 90-180° C. which is lower than a temperature of 200-280° C. of conventional thermal transfer methods, thereby preventing the deformation of a subject and the emission of toxic gas from the thermal transfer paper so as to be safe for workers.

### REFERENCE TO RELATED APPLICATIONS

This is a continuation of pending International Patent Application PCT/KR 2013/009786, filed on Oct. 31, 2013, which designates the United States and claims priority of Korean Patent Application No. 10-2013-0121292, filed on Oct. 11, 2013, the entire contents of which are incorporated herein by reference.

### FIELD OF THE INVENTION

The present invention relates to a thermal transfer paper for various printing techniques, including digital printing, and more particularly, to a thermal transfer paper for printing, the thermal transfer paper being used regardless of printing methods and types of ink, preventing deformation of a subject, preventing emission of toxic gas from the transfer paper and thus being safe for workers while also having excellent print color formation, preventing ink from smearing and thus improving resolution, and having an effect of covering stains and scratches on fabric.

### BACKGROUND OF THE INVENTION

Typically, after a text or a design to be transferred is screen printed on a thermal transfer paper, the thermal transfer paper is pressed onto a transfer target object or a transfer target paper and heat is applied to the thermal transfer paper to thereby transfer the text or design which was printed on the thermal transfer paper.

For a typical thermal transfer paper used for such a purpose, preparations are made for the transfer after a text or a design to be transferred onto a surface of a typical paper is screen printed and an adhesive powder is sprayed on the surface of the printed design.

In such a state, a transfer target object is pressed onto the design surface and then heat is applied to the thermal transfer paper such that, as an adhesive layer is adhered to the transfer target object, the screen printed design is also peeled of with the adhesive layer. Thus, even when the adhesive layer is formed by spraying the adhesive powder after printing the design on the thermal transfer paper, the adhesive powder is adhered not only to the design but also to the thermal transfer paper, and thus causes the resolution of the design to be degraded after the transfer.

Processes requiring the thermal transfer paper include various printing and digital printing, and the like, and in particular, the printing methods include silk screen printing, gravure printing, offset printing, and the like.

The gravure printing is an intaglio printing method in which printing is performed using recessed plates which are formed by applying photographic techniques. The recessed plate is called a gravure, which is short for photo-gravure, and printing is performed by filling recessed portions with liquid ink while using a knife to remove the ink from the other portions. Since the gravure can display gradations according to the depth of the plate to express an abundance of tones and give a strong impression, the gravure may be applied in a wide variety of areas including not only books, commercial prints, art prints, and the printing of stamps, but also for cellophane or plastic films having a poor absorbing property, printing of packaging such as aluminum foil, printing of construction materials, and the like. Among the three types of printing plates, that is, a relief plate, a recessed plate, and a flat plate, offset printing is a printing method that employs the flat plate. Printing is not performed by using the plate directly on an object to be printed. Instead, before printing on paper, transfer printing is first performed on a rubber blanket which serves as an intermediary. Lithographic printing using metal plates is usually performed using offset printing, and thus lithographic printing and offset printing are typically used to indicate the same thing. The silk screen printing is also called screen printing, process printing. Although there are numerous methods for creating patterns, for simple text or line drawings, either the simple text or line drawings are drawn directly on silk using shellac varnish, or shellac varnish which is painted on parchment paper is applied to the original drawing with hair oil, the outline is cut with a knife, parts of the parchment paper with text or drawings are removed and place on the silk, and the back side of the silk is heated with an iron such that the pattern is adhered to the silk. For complex drawings or small text, a photoresist formed by mixing gelatin with potassium dichromate is applied on the silk and dried, and then a positive is printed thereon and developed using warm water to dissolve and remove the gelatin on which the photoresist was not applied and thereby create the pattern. Moreover, there also exists a method in which a print that was printed on a photosensitive material adhered to carbon tissue is transferred to a silk fabric and then developed to create a pattern.

As above, numerous printing methods exist, various types of ink are required in accordance to the printing methods, and accordingly, many different types of thermal transfer paper are needed. Moreover, since thermal transfer must take place at high temperatures, deformation of a subject often occurs and toxic gas is emitted from the thermal transfer paper, and thus there is a limitation in that the work is difficult.

Meanwhile, up to now, digitally printed sheets have typically been provided as banners or textile prints which are printed by simply coating fabric with a resin and then printing an oil-based ink. In order for the prints printed on such fabric or paper, or the prints printed with solvent ink on PVC, synthetic paper, PET banners, PP banners, or sheet paper to be attached to various fixtures, it was necessary to apply a separate adhesive to the fabric, the paper, or the printed sheet, and thus attachment to the fixtures could only be realized through the adhesive properties of such adhesives.

In addition, in order to protect the patterns and prevent decolorization in the printed sheets which are printed in such a manner, a separate process such as laminating the printed design with a transparent sheet or applying a coat of paint is needed.

Furthermore, unlike a typical thermal transfer paper which includes an adhesive layer, a print layer, a peeling layer, and a sheet, since a typical laminating sheet for printing does not have separate adhesive and print layers, the laminating sheet is not a color printing paper and thus is unsuitable for being instantly attached directly onto target surfaces of various fixtures.

Thus, typical laminating sheets such as fabric, paper, or printed sheets are limited in that it is impossible to directly attach such laminating sheets to the target surfaces of various fixtures through thermal transfer.

In order to overcome such limitations, a thermal transport paper including a color transparent layer that absorbs solvent ink sprayed by a digital printer, and a transport sheet has been proposed. However, as in the above printing methods, thermal transfer is only possible at high temperatures, and thus a subject is deformed, toxic gas is emitted from the thermal transfer paper, and ink is smeared. Consequently, there are limitations in that the resolution is reduced, the print color formation is reduced, a separate drying device is needed, and adjusting the texture and gloss of the fabric is impossible.

Therefore, there is currently a demand for developing a thermal transfer paper that can overcome the numerous limitations.

### SUMMARY OF THE INVENTION

A first object of the present invention is to provide a thermal transfer paper that can be used regardless of the printing methods and the kinds of ink which follows from the printing method, and allows thermal transfer at a temperature of 90° C. to 180° C. which is lower than a temperature of 200° C. to 280° C. of a typical thermal transfer method. Thus, deformation of a subject does not occur and since a toxic gas is not emitted from the transfer paper, the thermal transfer paper is safe for workers and ecologically friendly. A second object of the present invention is to provide a thermal transfer paper that has excellent print color formation, prevents smearing of ink and thus has an improved resolution, and provides an effect of covering stains and scratches. A third object of the present invention is to provide a thermal transfer paper in which the ink dries quickly such that there is an advantage of not requiring a separate drying device or drying operation, adjusting the texture and gloss of a fabric is possible, a coating operation may be completed in a single coating operation to thereby reduce the production cost, and the defect rate may be reduced.

In the present invention for realizing the objects, a thermal transfer paper includes a release paper and a thermal transfer layer, the thermal transfer layer being a semitransparent or opaque coating layer in which ink used by a printer or digital printer is absorbed to form a color patterned layer.

An embodiment of the present invention such as described above may be used regardless of the printing method and the kind of ink which follows from the printing method, and allows thermal transfer at a lower temperature than a typical thermal transfer method. Thus, not only does deformation of a subject not occur, since toxic gas is not emitted from the transfer paper, the thermal transfer paper is safe for workers.

In addition, print color formation is excellent, ink smearing does not occur and thus resolution is improved, there is an effect of covering fabric stains and scratches, and there is an ecologically friendly advantage in that waste fabric and waste leather which can cause environmental pollution may be reused such that not only is the degree of recycling high, but the waste fabric and leather may be refabricated into high quality fabric having beautiful patterns or superb colors.

Moreover, due to the quick drying of ink when printing the thermal transfer paper, there is an advantage of a separate drying device and a separate drying operation not being needed, and it is possible to adjust the texture and gloss of the fabric.

Furthermore, the present invention is an economical and useful invention in which a coating operation may be completed in a single coating operation to thereby reduce the production cost, and the defect rate may be reduced.

### DETAILED DESCRIPTION OF THE INVENTION

Hereinafter, embodiments of the present invention are described.

A thermal transfer paper for printing or digital printing according to an embodiment of the present invention includes a release paper and a thermal transfer layer, the release paper being a semitransparent or opaque coating layer in which ink used by a printer or digital printer is absorbed to form a color patterned layer.

Typically, the transparency of the thermal transfer layer is critical in determining the quality of the color formation, resolution, and the like of the results of printing and digital printing.

When the thermal transfer layer is transparent, the limitations of the color pattern of the ink which is absorbed in the thermal transfer layer having a low resolution and the print color formation being degraded occur when performing the thermal transfer. Thus, when the thermal transfer layer is in a semitransparent state that maintains a white color or an opaque state which is not transparent, an excellent color print formation and an improved resolution may be achieved, and there is also an effect of covering scratches generated on a subject, that is, a fabric, which is subject to the thermal transfer.

During printing or digital printing, when the thermal transfer layer of the thermal transfer paper is coated with ink, the thermal transfer layer bonds with a filler and easily absorbs ink. Thus, the absorbed ink is contained in the thermal transfer layer. With respect to expressing the innate color of the ink, the print color formation of the innate color of the ink is deeper when the thermal transfer layer is formed to be semitransparent, for example, white, or opaque. Due to the semitransparent, for example, white, or opaque properties, smearing of ink in the printed text or design is absorbed and thereby prevented such that an end line can be clearly seen.

Moreover, when printing or digital printing the thermal transfer paper, since ink is absorbed in the opaque or semitransparent thermal transfer layer in the thermal transfer paper according to an embodiment of the inventive concept, natural drying of the ink is quickly achieved, and thus there is an advantage of not requiring a drying device, such as a preheating plate or a hot air dryer, which is needed when printing with a typical method, in particular when printing using a solvent device.

In particular, the thermal transfer layer is formed by mixing at least one hot melt resin selected from the group consisting of latex, rubber, aqueous urethane, polybutanol, urea, urethane, acrylic, vinyl resin, vinyl acetate, PVC resin, ethylene-vinyl acetate copolymer (EVA), and thermoplastic polyurethane (TPU), a surface tension agent, a dispersant, a filler, a quencher, a texturizer, a water-based solvent, an oil-based solvent, a plasticizer, a thickener, a brightener, a UV blocker, and a UV absorber.

Deionized water is used as the water-based solvent, and the oil-based solvent is formed by mixing one or more selected from among isopropyl alcohol (IPA), ethyl alcohol, methyl alcohol, water, toluene, methyl ethyl ketone (MEK), xylene, ethyl acetate, ethyl cellosolve, butyl acetate, propylene glycol monomethyl ether, butyl carbitol, and anone.

The filler is formed by mixing one or more selected from among titanium, nitrocellulose, an alumina sol, a sealant, an aerosol, and calcium carbonate. By using such a filler, there is an advantage in that the level of glossiness, that is, glossy, no gloss, or intermediate gloss, may be adjusted according to the input ratio between the filler and the resin included in the thermal transfer layer.

Silicone or a modified silicone may be used for the texturizer. By using such a texturizer, there is an advantage in that the texture of the surface of the transferred object which was transferred to the subject may be adjusted to be soft or hard.

Moreover, the thermal transfer layer is coated to a predetermined thickness on the release paper using a comma knife, and then dried for 2 to 4 minutes in a drying kiln which is temperature controlled to be 120° C. to 150° C.

The thickness of the thermal transfer layer which is coated on the release paper is about 10 to 70 microns. The thermal transfer paper which is completely dried in the drying kiln is stored by being wound on a drying rack.

The drying rack is a paper roll on which the thermal transfer paper is wound. The completely dried thermal transfer paper is wound to a jumbo-sized roll.

Typically, in order to manufacture the thermal transfer paper by forming the thermal transfer layer on the release paper, a gravure copper plate is etched and coated with a coating solution. Thus, due to mesh traces (called pockmarks) of the etched grooves, not only is it difficult to apply the coating solution in a precise manner, since a large amount of the coating solution cannot be applied in a single application, the coating solution must be applied about three times to complete the coating operation. However, in the present invention, a large amount may be coated in a single application by comma coating with a comma knife, and thus a precise coating may be achieved. Consequently, the quality may be improved such that the production cost and the defect rate are reduced, and thus the present invention is an economical and useful invention.

The ink used in the thermal transfer paper for printing or digital printing according to an embodiment of the present invention is one of a water-based ink, a solvent ink, or a UV ink. The water-based ink is formed of deionized water as a solvent, one selected as a coloring from among an ionic organic dye, an ionic organic pigment, and a mixture thereof, a dispersant, a surface tension agent, and a humectant. In particular, the water-based ink is mostly used in the thermal transfer paper used for digital water-based printing.

Moreover, the UV ink is formed of a reactive diluent, a photopolymerizable resin, an oligomer, one selected from among an ionic organic dye, an ionic organic pigment, and a mixture thereof, an assisting agent, a polymerization inhibitor, and a thickener. The assisting agent is a mixture of a viscosity enhancer, an antioxidant, a wetting adjuster, and a dispersant. The UV ink is used in the thermal transfer paper used for digital UV printing.

The solvent ink is formed of a solvent, one selected as a coloring from among an ionic organic dye, an ionic organic pigment, and a mixture thereof, a dispersant, and a surface tension agent. The solvent ink is used in the thermal transfer paper used for digital solvent printing, and also in the thermal transfer paper used for printing.

That is, the solvent ink is also used in the thermal transfer papers used for gravure printing, silk screen printing, and offset printing.

Most of the ink which is typically used uses a pigment having a large particle size. Therefore, the coloring substance in the ink is unable to permeate to a transparent adhesive layer in the thermal transfer layer, and thus does not become completely adhered to an adherend, but is instead disadvantageously detached from the surface. However, the ink used in the thermal transfer paper according to an embodiment of the present invention uses an ionic dye having a small particle size or a mixture of an ionic dye and an organic pigment, and thus has the advantage of being completely absorbed in the thermal transfer layer so as to become completely adhered to the subject during the thermal transfer.

Moreover, although a thermal transfer paper is typically used in accordance with the printing method and the kind of ink, the thermal transfer paper according to an embodiment of the present invention has the advantage, which is described above, of being able to be used regardless of the printing method or the kind of ink according to the printing method.

As above, the thermal transfer paper according to an embodiment of the present invention may be used in all printing methods, such as gravure printing, offset printing, silk screen printing, and photoimageable LED printing, and may be respectively used according to the printing methods in printers, that is, in offset printers, UV offset printers, gravure printers, silk screen printers, indigo printers, digital print printers, digital water-based printers, solvent printers, latex printers, UV digital printers, water-based planographic printers, solvent planographic printers, mid to small-sized printers, common printers, laser printers, and copiers, and the like.

In addition, the kind of ink used changes in accordance to the various printing methods and printers. The thermal transfer paper may be used regardless of the kind of ink, and the various kinds of ink include water-based latex pigment inks for digital printing, water-based pigment inks for digital printing, water-based dye inks for digital printing, water-based dye and pigment mixture inks for digital printing, solvent pigment inks for digital printing, solvent dye inks for digital printing, solvent dye and pigment mixture inks for digital printing, UV pigment inks for digital printing, water-based emulsion pigment inks for silk screen printing, water-based emulsion dye inks for silk screen printing, offset printing inks, UV offset printing inks, indigo printing inks, gravure printing inks, and laser printer toners, and the like.

The present invention as described above has the property or enabling thermal transfer at temperatures which are lower than those of typical thermal transfer methods. Consequently, not only does a deformation of the subject not occur, toxic gas is not emitted from the thermal transfer paper. Therefore, the present invention is useful and safe for workers.

What is claimed is:

1. A thermal transfer paper for printing or digital printing, the thermal transfer paper comprising a release paper and a thermal transfer layer, the release paper being a semitransparent or opaque coating layer in which ink used by a printer or digital printer is absorbed to form a color patterned layer.

2. The thermal transfer paper of claim 1, wherein the thermal transfer layer is formed by mixing at least one hot melt resin selected from the group consisting of latex, rubber, aqueous urethane, polybutanol, urea, urethane, acrylic, vinyl resin, vinyl acetate, PVC resin, ethylene-vinyl acetate copolymer (EVA), and thermoplastic polyurethane (TPU), a surface tension agent, a dispersant, a filler, a quencher, a texturizer, a water-based solvent, an oil-based solvent, a plasticizer, a thickener, a brightener, a UV blocker, and a UV absorber.

3. The thermal transfer paper of claim 1, wherein the thermal transfer layer is coated to a predetermined thickness on the release paper using a comma knife, and then dried for 2 to 4 minutes in a drying kiln which is temperature controlled to be 120° C. to 150° C.

4. The thermal transfer paper of claim 1, wherein the ink is one selected from among a water-based ink, a solvent ink, and a UV ink.

5. The thermal transfer paper of claim 4, wherein the water-based ink is formed of deionized water as a solvent, one selected as a coloring from among an ionic organic dye, an ionic organic pigment, and a mixture thereof, a dispersant, a surface tension agent, and a humectant.

6. The thermal transfer paper of claim 4, wherein the solvent ink is formed of a solvent, one selected as a coloring from among an ionic organic dye, an ionic organic pigment, and a mixture thereof, a dispersant, and a surface tension agent.

7. The thermal transfer paper of claim 4, wherein the UV ink is formed of a reactive diluent, a photopolymerizable resin, an oligomer, one selected from among an ionic organic dye, an ionic organic pigment, and a mixture thereof, an assisting agent, a polymerization inhibitor, and a thickener.

8. The thermal transfer paper of claim 7, wherein the assisting agent is a mixture of a viscosity enhancer, an antioxidant, a wetting adjuster, and a dispersant.

9. The thermal transfer paper of claim 2, wherein the oil-based solvent is formed by mixing one or more selected from among isopropyl alcohol (IPA), ethyl alcohol, methyl alcohol, water, toluene, methyl ethyl ketone (MEK), xylene, ethyl acetate, ethyl cellosolve, butyl acetate, propylene glycol monomethyl ether, butyl carbitol, and anone.

10. The thermal transfer paper of claim 2, wherein the filler is formed by mixing one or more selected from among titanium, nitrocellulose, an alumina sol, a sealant, an aerosol, and calcium carbonate.

11. The thermal transfer paper of claim 2, wherein the texturizer is a silicone or a modified silicone.
